(19) United States
(12) Patent Application Publication
(10) Pub. No.: US 2026/0358296 A1
(43) Pub. Date: Nov. 12, 2026

(54) ULTRASONIC FLAW DETECTION APPARATUS AND ULTRASONIC FLAW DETECTION METHOD

(71) Applicant: IHI Corporation, Tokyo (JP)

(72) Inventors: Shuhei HASHIMOTO, Tokyo (JP); Kohei KUDO, Tokyo (JP)

(73) Assignee: IHI Corporation, Tokyo (JP)

(21) Appl. No.: 19/720,403

(22) Filed: Jun. 25, 2026

Related U.S. Application Data
(63) Continuation of application No. PCT/JP2025/013475, filed on Apr. 2, 2025.

(30) Foreign Application Priority Data
Jul. 5, 2024 (JP) 2024-109052

(51) Int. Cl. G01N 29/04; G01N 29/27

(52) U.S. Cl. CPC G01N 29/04; G01N 29/27; G01N 2291/023; G01N 2291/106

(57) ABSTRACT

An ultrasonic flaw detection apparatus performs ultrasonic flaw detection of an inspection target from an inner side of an inner peripheral surface of the inspection target. The inspection target has a complete or partial annular shape with the inner peripheral surface extending along the complete or partial annular shape. The ultrasonic flaw detection apparatus includes: a probe unit including first and second ultrasonic probes; and a rotation unit configured to rotate the inspection target relative to the probe unit around a central axis of an inner peripheral surface of the inspection target. The first and second ultrasonic probes include first and second ultrasonic transducers configured to irradiate ultrasonic waves from the central axis toward the inner peripheral surface in different directions, respectively. Static first and second irradiation range angles of the first and second ultrasonic transducers viewed from a direction of the central axis are different from each other.

### CROSS-REFERENCE TO RELATED APPLICATIONS

The present application is a continuation of International Application No. PCT/JP2025/013475, filed on Apr. 2, 2025, and based upon and claims the benefit of priority from Japanese Patent Application No. 2024-109052, filed on Jul. 5, 2024), the entire contents of which are incorporated herein by reference.

### TECHNICAL FIELD

The present disclosure relates to an ultrasonic flaw detection apparatus and an ultrasonic flaw detection method.

### BACKGROUND

Japanese Patent Application Publication No. 2002-22714 discloses an ultrasonic flaw detection apparatus as a flaw detection apparatus. The ultrasonic flaw detection apparatus is a nondestructive inspection apparatus that uses ultrasonic waves to detect defects inside an inspection target.

### SUMMARY

Flaw detection of an inspection target having a complex shape may be difficult to carry out due to interference caused by reflection of ultrasonic waves. For this reason, CT flaw detection using X-rays is performed on an inspection target having a complex shape. When CT flaw detection is performed on an inspection target having a large part made of a metal having a high X-ray attenuation coefficient, flaw detection may not be possible because the portion thereof to be subjected to flaw detection is thick and X-rays cannot transmit therethrough sufficiently. In such cases, CT flaw detection using high-energy X-rays is required. However, a CT apparatus using high-energy X-rays involves enormous introduction costs, making it difficult to introduce.

The present disclosure is directed to an ultrasonic flaw detection apparatus and an ultrasonic flaw detection method capable of performing ultrasonic flaw detection even on a thick inspection target.

An ultrasonic flaw detection apparatus according to the present disclosure performs ultrasonic flaw detection of an inspection target from an inner side of an inner peripheral surface of the inspection target. The inspection target has a complete annular shape with the inner peripheral surface extending along the complete annular shape or has a partial annular shape with the inner peripheral surface extending along the partial annular shape. The ultrasonic flaw detection apparatus includes: a probe unit including a first ultrasonic probe and a second ultrasonic probe; and a rotation unit configured to rotate the inspection target relative to the probe unit around a central axis of the inner peripheral surface of the inspection target. The first ultrasonic probe includes a first ultrasonic transducer configured to irradiate ultrasonic waves from the central axis toward the inner peripheral surface in a first direction. The second ultrasonic probe includes a second ultrasonic transducer configured to irradiate ultrasonic waves from the central axis toward the inner peripheral surface in a second direction different from the first direction. The probe unit is configured such that a static first irradiation range angle of the first ultrasonic transducer and a static second irradiation range angle of the second ultrasonic transducer viewed from a direction of the central axis are different from each other.

The probe unit may be configured such that the static first irradiation range angle and the static second irradiation range angle viewed from the direction of the central axis are different from each other by making a curvature of a first vibrating surface on which the first ultrasonic transducer is provided differ from a curvature of a second vibrating surface on which the second ultrasonic transducer is provided.

An ultrasonic flaw detection method according to the present disclosure uses the ultrasonic flaw detection apparatus described above. The method includes: arranging the probe unit on the central axis of the inner peripheral surface; and performing flaw detection by irradiating the ultrasonic waves from the first ultrasonic probe and the second ultrasonic probe toward the inner peripheral surface while rotating the inspection target around the central axis relative to the probe unit by the rotation unit.

In the ultrasonic flaw detection method, the inspection target may have the complete annular shape with the inner peripheral surface extending along the complete annular shape, and flaw detection may be performed by rotating the inspection target one full turn around the central axis relative to the probe unit while simultaneously irradiating the ultrasonic waves respectively from the first ultrasonic probe and the second ultrasonic probe toward the inner peripheral surface of the inspection target.

In the ultrasonic flaw detection method, the inspection target may be a product manufactured by Metal Additive Manufacturing.

According to the present disclosure, ultrasonic flaw detection can be performed even on a thick inspection target.

### BRIEF DESCRIPTION OF DRAWINGS

FIG. 1 is a schematic perspective view illustrating a configuration of an ultrasonic flaw detection apparatus according to an embodiment.

FIG. 2 is a schematic plan view of the apparatus.

FIG. 3 is a schematic perspective view of a first ultrasonic probe of the apparatus.

FIG. 4 is a schematic perspective view of a second ultrasonic probe of the apparatus.

### DETAILED DESCRIPTION

Hereinafter, an ultrasonic flaw detection apparatus according to an embodiment will be described with reference to the drawings.

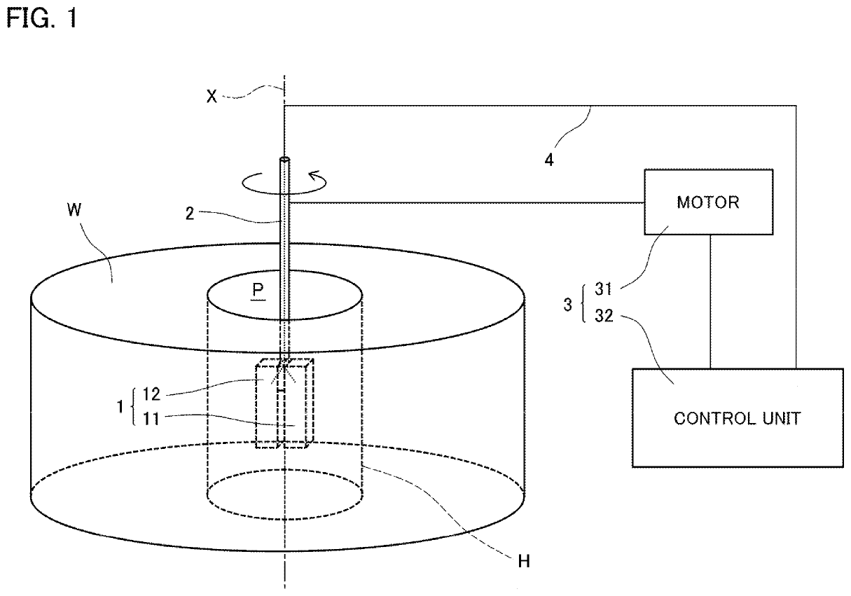

As illustrated in FIG. 1, an ultrasonic flaw detection apparatus (hereinafter simply referred to as “apparatus”) performs flaw detection of an annular inspection target W. A hole H is formed at the center of the inspection target W, and flaw detection is performed by irradiating ultrasonic waves from an inner side of the hole H toward an inner peripheral surface P. In the present embodiment, the inspection target W has a complete annular shape, and ultrasonic flaw detection is performed along the entire circumference of the inner peripheral surface P. However, the inspection target W may have a partial annular shape, for example, a semi-annular shape. In this case, the inner peripheral surface P covers only part of the entire circumference, that is, only a half circumference, but ultrasonic flaw detection may be performed along only this half circumference. The inspection target W is placed in a water tank (not illustrated) filled with a couplant, that is, water as a coupling medium.

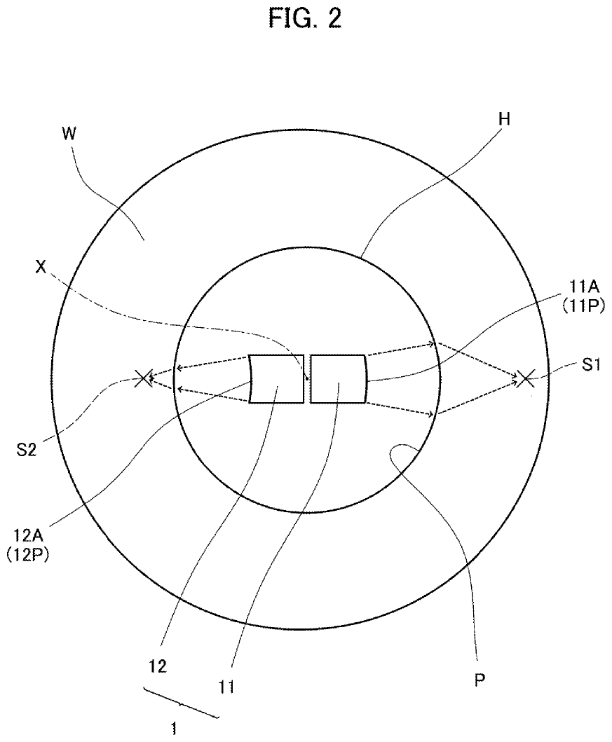

The inspection target W of the present embodiment is a product manufactured by Metal Additive Manufacturing. Metal Additive Manufacturing is a manufacturing method capable of manufacturing products having complex shapes. However, in FIGS. 1 and 2, only the annular shape is schematically illustrated. In a product manufactured by Metal Additive Manufacturing, defects specific to products manufactured by Metal Additive Manufacturing, such as incomplete fusion of metal powder, may occur inside the product. Such portions of incomplete fusion are also subject to flaw detection. Since portions of incomplete fusion take a form in which voids are filled with metal powder, the volume of the voids is small and the intensity of ultrasonic echoes is weak, making detection by ultrasonic flaw detection difficult. Metal Additive Manufacturing is performed, for example, by a 3D printer, and includes, in addition to Powder Bed Fusion (PBF) that uses the aforementioned metal powder, Direct Energy Deposition (DED) and Fused Deposition Modeling (FDM).

The apparatus includes a probe unit 1 that transmits ultrasonic waves and receives reflected waves thereof. The probe unit 1 has a pair of a first ultrasonic probe 11 and a second ultrasonic probe 12. Each of the first ultrasonic probe 11 and the second ultrasonic probe 12 transmits ultrasonic waves and receives reflected waves thereof. The first ultrasonic probe 11 and the second ultrasonic probe 12 are attached to the tip of a rod 2 and are directed in mutually opposite directions. During flaw detection, the rod 2 is arranged so as to coincide with the central axis X of the inner peripheral surface P, and is rotated around the central axis X by a rotation unit 3 described later. By the rotation of the rod 2, the probe unit 1 is rotated around the central axis X inside the inspection target W. That is, the first ultrasonic probe 11 and the second ultrasonic probe 12 are simultaneously rotated around the central axis X.

The rotation unit 3 described above includes a motor 31, which is a drive source for rotating the rod 2, and a control unit 32 that controls the motor 31. The motor 31 is connected to the control unit 32. The rotation of the motor 31, that is, the rotation of the probe unit 1, is controlled by the control unit 32. The control unit 32 also controls the entire apparatus. The control unit 32 is a computer and includes a central processing unit (CPU) that performs arithmetic operations, storage that stores an operating system, a flaw detection program, and the like, memory used during arithmetic operations, a signal input/output device, a monitor, and the like.

The probe unit 1, that is, the first ultrasonic probe 11 and the second ultrasonic probe 12, are also connected to the control unit 32 via a connecting line 4. Power is supplied from the control unit 32 to the first ultrasonic probe 11 and the second ultrasonic probe 12 via the connecting line 4. The control unit 32 also transmits and receives signals to and from the first ultrasonic probe 11 and the second ultrasonic probe 12 via the connecting line 4. That is, the control unit 32 controls the transmission of ultrasonic waves by the first ultrasonic probe 11 and the second ultrasonic probe 12 and receives detection results from the first ultrasonic probe 11 and the second ultrasonic probe 12. The control unit 32 post-processes the received detection results to generate data for flaw detection and displays the generated data on a monitor or the like. The control unit 32 itself may determine whether a defect is present and output the determination result.

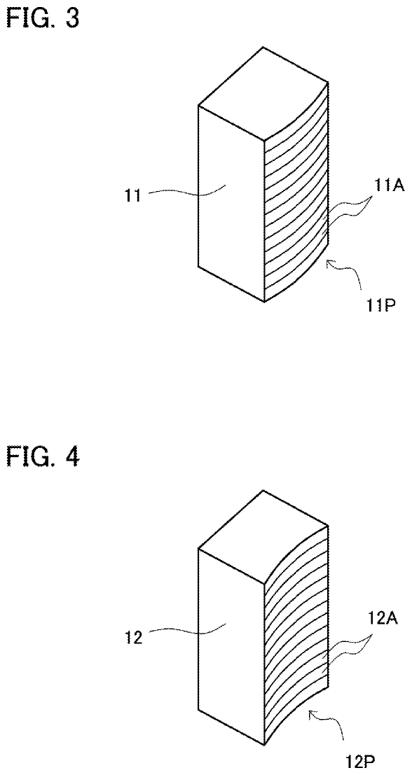

As indicated by the dotted arrows in FIG. 2, the first ultrasonic probe 11 has a first ultrasonic transducer 11A on a first vibrating surface 11P. The first ultrasonic transducer 11A irradiates ultrasonic waves from the central axis X toward the inner peripheral surface P. Similarly, the second ultrasonic probe 12 has a second ultrasonic transducer 12A on a second vibrating surface 12P. The second ultrasonic transducer 12A irradiates ultrasonic waves from the central axis X toward the inner peripheral surface P. As described above, the first ultrasonic probe 11 and the second ultrasonic probe 12 are directed in mutually opposite directions. That is, the first vibrating surface 11P on which the first ultrasonic transducer 11A is provided (see FIG. 3) and the second vibrating surface 12P on which the second ultrasonic transducer 12A is provided (see FIG. 4) are directed in mutually opposite directions. Therefore, the second ultrasonic transducer 12A transmits ultrasonic waves in a direction (second direction) different from a direction (first direction) in which the first ultrasonic transducer 11A transmits ultrasonic waves. In the present embodiment, the directions in which the first ultrasonic transducer 11A and the second ultrasonic transducer 12A transmit ultrasonic waves differ from each other by 180 degrees around the central axis X.

As illustrated in FIG. 2, the probe unit 1 is configured such that, when viewed from the direction of the central axis X, the static first irradiation range angle of the first ultrasonic transducer 11A and the static second irradiation range angle of the second ultrasonic transducer 12A are different from each other. In the present embodiment, the first irradiation range angle is set such that ultrasonic waves transmitted from the first vibrating surface 11P diverge. On the other hand, the second irradiation range angle is set such that ultrasonic waves transmitted from the second vibrating surface 12P converge. In the present embodiment, as illustrated in FIGS. 3 and 4, these irradiation range angles are mechanically differentiated by making the curvatures of the vibrating surfaces 11P and 12P differ from each other. As illustrated in FIG. 3, the first vibrating surface 11P of the first ultrasonic probe 11 is convexly curved, and the second vibrating surface 12P of the second ultrasonic probe 12 is concavely curved.

The “static” irradiation range angle referred to herein refers to an irradiation angle of the ultrasonic waves of the first ultrasonic probe 11 and the second ultrasonic probe 12 that are not rotating, and is one of the values relating to the directional characteristics of the ultrasonic sensors. As the “static” irradiation range angle, for example, a so-called “sound pressure half-angle” or the like can be used. During flaw detection, the first ultrasonic probe 11 and the second ultrasonic probe 12 irradiate ultrasonic waves toward the inner peripheral surface P while rotating, but the “static” irradiation range angle differs from the “dynamic” irradiation angle during this rotational scanning. When an ultrasonic probe having a “static” irradiation range angle is rotated, the “static” irradiation range angle is also moved in the rotational direction, thereby expanding the irradiation range. The “dynamic” irradiation range angle refers to the irradiation range angle that includes the range expansion due to the rotational movement of the “static” irradiation range angle.

In the present embodiment, the first irradiation range angle of the first ultrasonic probe 11 is set so as to cause ultrasonic waves to diverge, and as illustrated in FIG. 2, the first ultrasonic probe 11 detects a defect S1 that exists at a deep position from the inner peripheral surface P. That is, the flaw detection range of the first ultrasonic probe 11 is at a deep position from the inner peripheral surface P. On the other hand, the second irradiation range angle of the second ultrasonic probe 12 is set so as to cause ultrasonic waves to converge, and as illustrated in FIG. 2, the second ultrasonic probe 12 detects a defect S2 that exists at a shallow position from the inner peripheral surface P. That is, the flaw detection range of the second ultrasonic probe 12 is at a shallow position from the inner peripheral surface P. Ultrasonic waves are also refracted at the surface of the inner peripheral surface P to reach a targeted flaw detection depth. In this manner, since the flaw detection depths of the first ultrasonic probe 11 and the second ultrasonic probe 12 differ from each other, flaw detection can be performed even if the inspection target W is thick in the direction in which the ultrasonic waves are transmitted.

In the present embodiment, as illustrated in FIG. 3, a plurality of first ultrasonic transducers 11A are provided on the first vibrating surface 11P of the first ultrasonic probe 11 along the central axis X. Similarly, as illustrated in FIG. 4, a plurality of second ultrasonic transducers 12A are provided on the second vibrating surface 12P of the second ultrasonic probe 12 along the central axis X. That is, each of the ultrasonic probes 11 and 12 is a linear array probe. By arranging the plurality of ultrasonic transducers 11A and 12A in this manner, flaw detection using the aperture synthesis method described later can be performed.

In the present embodiment, the probe unit 1 is rotated around the central axis X inside the inspection target W by the rotation unit 3, but the inspection target W may be rotated around the probe unit 1, that is, around the central axis X. In this case, the rotation unit 3 rotates the inspection target W. For example, the inspection target W is placed on a turntable, and the rotation unit 3 rotates the turntable. That is, the rotation unit 3 rotates the inspection target W “relatively” with respect to the probe unit 1. At this time, only the inspection target W may be rotated, or only the probe unit 1 may be rotated. Alternatively, the inspection target W may be rotated “relatively” with respect to the probe unit 1 by rotating both the inspection target W and the probe unit 1 around the central axis X at different rotational speeds.

Prior to flaw detection, calibration using a calibration block is performed in advance in place of the inspection target W. As the calibration block, a block in which a drill hole simulating a normal defect is formed, or a block manufactured by Metal Additive Manufacturing in which a portion of incomplete fusion is intentionally formed inside, or the like is used. During flaw detection of the inspection target W, the probe unit 1 is arranged on the central axis X of the inner peripheral surface P. Here, prior to the rotational scanning of the probe unit 1, fine adjustment of the distance between the first ultrasonic probe 11 and the second ultrasonic probe 12 and the inner peripheral surface P is also performed. Although not illustrated in the drawings, a mechanism for finely adjusting the distance between the first vibrating surface 11P of the first ultrasonic probe 11 and the inner peripheral surface P is provided between the first ultrasonic probe 11 and the rod 2, or inside the first ultrasonic probe 11. A similar fine adjustment mechanism is also provided for the second ultrasonic probe 12.

Thereafter, flaw detection, that is, rotational scanning, is performed by irradiating ultrasonic waves from the first ultrasonic probe 11 and the second ultrasonic probe 12 toward the inner peripheral surface P while rotating the inspection target W relative to the probe unit 1 around the central axis X by the rotation unit 3. Data for flaw detection of a deep portion from the inner peripheral surface P is acquired by the first ultrasonic probe 11 by means of ultrasonic waves transmitted from the first ultrasonic probe 11. Data for flaw detection of a shallow portion from the inner peripheral surface P is acquired by the second ultrasonic probe 12 by means of ultrasonic waves transmitted from the second ultrasonic probe 12.

In the present embodiment, since the first ultrasonic probe 11 and the second ultrasonic probe 12 face in opposite directions, they are less susceptible to the influence of ultrasonic waves transmitted by each other and ultrasonic echoes, which are reflected waves thereof. Also, in the present embodiment, in particular, the inspection target W has a complete annular shape. Ultrasonic waves are simultaneously irradiated respectively from the rotating first ultrasonic probe 11 and second ultrasonic probe 12 toward the entire circumference of the annular inner peripheral surface P. Therefore, by rotating the inspection target W one full turn around the central axis X relative to the probe unit 1, flaw detection of the entire circumference of the inner peripheral surface P is completed for both the first ultrasonic probe 11 and the second ultrasonic probe 12.

When scanning continues along the direction of the central axis X, rotational scanning is executed after the inspection target W has been moved one pass in the direction of the central axis X relative to the probe unit 1. Thereafter, axial feeding and rotational scanning are alternately performed. Data acquired by the probe unit 1, that is, by the first ultrasonic probe 11 and the second ultrasonic probe 12, is post-processed by the control unit 32. As described above, the ultrasonic probes 11 and 12 of the present embodiment are linear array probes each having the plurality of ultrasonic transducers 11A and 12A, respectively, along the central axis X. In the rotational scanning, the linear array probes, that is, the ultrasonic transducers 11A and 12A, are utilized effectively. Specifically, detection and data processing using the aperture synthesis method are performed.

The aperture synthesis method itself is a known technique, but using it in the present embodiment enables flaw detection to be suitably performed. For example, flaw detection can be performed using the FMC/TFM algorithm or the PWI algorithm, which are types of the aperture synthesis method. By performing sensitivity correction on data acquired using the aperture synthesis method based on these algorithms, more accurate flaw detection can be performed, and in particular, flaw detection of portions of incomplete fusion in products manufactured by Metal Additive Manufacturing can be performed very suitably. The calibration using the calibration block described above is effective for flaw detection using this aperture synthesis method.

In the ultrasonic flaw detection apparatus according to the above-described embodiment, ultrasonic flaw detection is performed from the inner side of the inner peripheral surface P of the annular inspection target W, and the apparatus includes the probe unit 1 having the first ultrasonic probe 11 and the second ultrasonic probe 12. The apparatus also includes the rotation unit 3 that rotates the inspection target W relative to the probe unit 1 around the central axis X of the inner peripheral surface P of the inspection target W. The first ultrasonic probe 11 has the first ultrasonic transducer 11A that irradiates ultrasonic waves from the central axis X toward the inner peripheral surface P. The second ultrasonic probe 12 has the second ultrasonic transducer 12A that irradiates ultrasonic waves from the central axis X toward the inner peripheral surface P in a direction different from that of the first ultrasonic transducer 11A. The probe unit 1 is configured such that, when viewed from the direction of the central axis X, the static first irradiation range angle of the first ultrasonic transducer 11A differs from the static second irradiation range angle of the second ultrasonic transducer 12A, as illustrated in FIG. 2.

For this reason, it is possible to simultaneously perform flaw detection with the first ultrasonic probe 11 and the second ultrasonic probe 12 while rotating the inspection target W relative to the probe unit 1 by the rotation unit 3. Here, the static first irradiation range angle of the first ultrasonic probe 11 and the static second irradiation range angle of the second ultrasonic probe 12 are differentiated. Therefore, the ultrasonic probes 11 and 12 can each perform flaw detection on portions at different depths from the inner peripheral surface P, and can perform flaw detection in a wide range in the depth direction with respect to the inner peripheral surface P, that is, in the radial direction of the annular inspection target W. Also, flaw detection is performed on portions at different depths, but since the first ultrasonic probe 11 and the second ultrasonic probe 12 are simultaneously rotated for flaw detection, flaw detection can be performed in a short time. Therefore, according to the apparatus of the above-described embodiment, ultrasonic flaw detection of an inspection target having a thick portion to be subjected to flaw detection can be suitably performed.

Also, in the above-described embodiment, the probe unit 1 is configured such that the first irradiation range angle and the second irradiation range angle differ by making the curvature of the first vibrating surface 11P differ from the curvature of the second vibrating surface 12P. By mechanically differentiating the irradiation range angles using curvature in this manner, the ultrasonic waves can be controlled efficiently, and the transmission and reception of ultrasonic waves can be performed stably. To differentiate the irradiation range angles, ultrasonic transducers 11A and 12A may be arranged also in a direction perpendicular to the direction of the central axis X on the vibrating surfaces 11P and 12P to form a matrix probe, and the static irradiation range angles of the ultrasonic waves may be variably controlled by controlling the transmission of the ultrasonic waves. However, in this case, the control of the ultrasonic waves becomes complicated, so differentiating the irradiation range angles mechanically as in the above-described embodiment makes it possible to achieve the desired flaw detection at a lower cost.

Also, in the ultrasonic flaw detection method using the apparatus of the above-described embodiment, the probe unit 1 is arranged on the central axis X of the annular inner peripheral surface P. Then, flaw detection is performed by irradiating ultrasonic waves from the first ultrasonic probe 11 and the second ultrasonic probe 12 toward the inner peripheral surface P while rotating the inspection target W around the central axis X relative to the probe unit 1 by the rotation unit 3. For this reason, as described above, flaw detection of all or part of the entire circumference of the inner peripheral surface P of the annular inspection target W can be performed efficiently in a short time.

In particular, in the method of the above-described embodiment, flaw detection of the entire circumference of the inner peripheral surface P of the inspection target W having a complete annular shape is performed. In this case, flaw detection is performed by rotating the inspection target W one full turn around the central axis X relative to the probe unit 1 while simultaneously irradiating ultrasonic waves respectively from the first ultrasonic probe 11 and the second ultrasonic probe 12 toward the inner peripheral surface P. For this reason, flaw detection at different depths over the entire circumference can be performed efficiently in only one rotation.

The inspection target W of the above-described embodiment was a product manufactured by Metal Additive Manufacturing. As described above, products manufactured by Metal Additive Manufacturing may have defects specific thereto, such as incomplete fusion, which are difficult to detect. According to the method of the above-described embodiment, such defects can also be detected by flaw detection using the first ultrasonic probe 11 and the second ultrasonic probe 12.

Although several embodiments have been described, it is possible to modify or vary the embodiments based on the above disclosure. All components of the above-described embodiments and all features described in the claims may be individually extracted and combined as long as they do not contradict each other.

For example, the apparatus of the above-described embodiment has two ultrasonic probes 11 and 12, but it is not always required to perform flaw detection using both of the two ultrasonic probes 11 and 12 simultaneously. The control unit 32 may control the apparatus so as to enable flaw detection using only one of the two ultrasonic probes 11 and 12.

In the above-described embodiment, the orientations of the ultrasonic probes 11 and 12 were directed in mutually opposite directions of 180 degrees. In this configuration, the ultrasonic probes become less susceptible to the influence of ultrasonic waves transmitted by each other and reflected ultrasonic echoes. However, the orientations of the ultrasonic probes 11 and 12 need not be 180 degrees as long as they differ from each other.

In the above-described embodiment, the static first irradiation range angle of the first ultrasonic probe 11 was set so as to cause ultrasonic waves to diverge, and the static second irradiation range angle of the second ultrasonic probe 12 was set so as to cause ultrasonic waves to converge. However, the configuration is not limited thereto, and it is sufficient that the irradiation range angles differ from each other. As long as the irradiation range angles differ, both may be diverging or both may be converging. Alternatively, the irradiation range angle of one of them may be diverging or converging, and the irradiation range angle of the other may be parallel, which is neither diverging nor converging. The irradiation range can be made parallel by making the first vibrating surface 11P or the second vibrating surface 12P flat instead of curved. As long as the irradiation range angles differ, different flaw detection depths can be achieved by the first ultrasonic probe 11 and the second ultrasonic probe 12.

What is claimed is:

1. An ultrasonic flaw detection apparatus configured to perform ultrasonic flaw detection of an inspection target from an inner side of an inner peripheral surface of the inspection target, the inspection target having a complete annular shape with the inner peripheral surface extending along the complete annular shape or having a partial annular shape with the inner peripheral surface extending along the partial annular shape, the ultrasonic flaw detection apparatus comprising:
a probe unit including a first ultrasonic probe and a second ultrasonic probe; and
a rotation unit configured to rotate the inspection target relative to the probe unit around a central axis of the inner peripheral surface of the inspection target, wherein
the first ultrasonic probe includes a first ultrasonic transducer configured to irradiate ultrasonic waves from the central axis toward the inner peripheral surface in a first direction,
the second ultrasonic probe includes a second ultrasonic transducer configured to irradiate ultrasonic waves from the central axis toward the inner peripheral surface in a second direction different from the first direction, and
the probe unit is configured such that a static first irradiation range angle of the first ultrasonic transducer and a static second irradiation range angle of the second ultrasonic transducer viewed from a direction of the central axis are different from each other.

2. The ultrasonic flaw detection apparatus according to claim 1, wherein the probe unit is configured such that the static first irradiation range angle and the static second irradiation range angle viewed from the direction of the central axis are different from each other by making a curvature of a first vibrating surface on which the first ultrasonic transducer is provided differ from a curvature of a second vibrating surface on which the second ultrasonic transducer is provided.

3. An ultrasonic flaw detection method using an ultrasonic flaw detection apparatus configured to perform ultrasonic flaw detection of an inspection target from an inner side of an inner peripheral surface of the inspection target, the inspection target having a complete annular shape with the inner peripheral surface extending along the complete annular shape or having a partial annular shape with the inner peripheral surface extending along the partial annular shape, the ultrasonic flaw detection apparatus comprising: a probe unit including a first ultrasonic probe and a second ultrasonic probe; and a rotation unit configured to rotate the inspection target relative to the probe unit around a central axis of the inner peripheral surface of the inspection target, wherein the first ultrasonic probe includes a first ultrasonic transducer configured to irradiate ultrasonic waves from the central axis toward the inner peripheral surface in a first direction, the second ultrasonic probe includes a second ultrasonic transducer configured to irradiate ultrasonic waves from the central axis toward the inner peripheral surface in a second direction different from the first direction, and the probe unit is configured such that a static first irradiation range angle of the first ultrasonic transducer and a static second irradiation range angle of the second ultrasonic transducer viewed from a direction of the central axis are different from each other, the method comprising:
arranging the probe unit on the central axis of the inner peripheral surface; and
performing flaw detection by irradiating the ultrasonic waves from the first ultrasonic probe and the second ultrasonic probe toward the inner peripheral surface while rotating the inspection target around the central axis relative to the probe unit by the rotation unit.

4. The ultrasonic flaw detection method according to claim 3, wherein the inspection target has the complete annular shape with the inner peripheral surface extending along the complete annular shape, and flaw detection is performed by rotating the inspection target one full turn around the central axis relative to the probe unit while simultaneously irradiating the ultrasonic waves respectively from the first ultrasonic probe and the second ultrasonic probe toward the inner peripheral surface of the inspection target.

5. The ultrasonic flaw detection method according to claim 3, wherein the inspection target is a product manufactured by Metal Additive Manufacturing.
